(19) United States
(12) Patent Application Publication
(10) Pub. No.: US 2012/0329893 A1
(43) Pub. Date: Dec. 27, 2012

(54) HYDROCHLOROFLUOROOLEFIN BLOWING AGENT COMPOSITIONS

(75) Inventor: Laurent Abbas, Narberth, PA (US)

(73) Assignee: Arkema France, Colombes (FR)

(21) Appl. No.: 13/583,032

(22) PCT Filed: Feb. 15, 2011
(86) PCT No.: PCT/FR2011/050317

§ 371 Date: Sep. 6, 2012

(30) Foreign Application Priority Data
Mar. 9, 2010 (FR) 1051683

(51) Int. Cl. C09K 3/00; C08J 9/14

(52) U.S. Cl. 521/78; 516/12

(57) ABSTRACT

The invention relates to the use of a composition as an agent for blowing a projected biocomponent polyurethane foam, said composition including 1-chloro-3,3,3-trifluoropropane and/or 2-chloro-3,3,3-trifluoropropene and at least one additional compound selected from among hydrochlorofluoroolefins, hydrofluoroolefins, hydrochloroolefins, hydrofluorocarbons, hydrochlorofluorocarbons, hydrocarbons, substituted or non-substituted ethers, substituted or non-substituted alcohols, substituted or non-substituted aldehydes, substituted or non-substituted ketones and substituted or non-substituted esters. Said composition has a boiling point greater than or equal to 20° C. The invention also relates to a method for manufacturing polyurethane foam on the basis of the use above and moreover relates to specific compositions that are appropriate for implementing the invention.

### FIELD OF THE INVENTION

The present invention relates to hydrochlorofluoro-olefin-based blowing agent compositions, and also the use of hydrochlorofluoroolefin-based blowing agent compositions for the production of two-component sprayed polyuretahae foams. The invention also provides certain particular blowing agent compositions suitable for the aforementioned use.

### TECHNICAL BACKGROUND

The methods for manufacturing polyurethane foams are known and in general consist in reacting an organic isocyanate compound with a polyol or a mixture of polyols in the presence of a blowing agent.

A difference is made between one-component formulations, for which the isocyanate compound and the polyol compound are mixed before expansion of the foam and two-component formulations, for which the isocyanate compound and the polyol compound are mixed during the expansion of the foam.

In the field of polyurethane foams, as in other fields, the Montreal protocol, which aims to limit the depletion of the ozone layer, has imposed strict regulations regarding the use of fluorinated products as blowing agents. CFCs (chlorofluorocarbons), the first generation of blowing agents, and HCFCs (hydro-chlorofluorocarbons), the second generation of blowing agents, have a relatively high ODP (ozone depletion potential). The third generation of blowing agents, that of HFCs (hydrofluorocarbons) has a negligible ODP.

These products are therefore widely used to date in the field of foams.

On the other hand, the GWP (global warming potential) of HFCs is relatively high. It has therefore been proposed to turn to a fourth generation of blowing agents, hydrochlorofluoroolefins (HCFOs or HFCOs), It is thus that document WO 2009/089511 describes the use of compositions based on hydrochlorofluoroolefins, and in particular based on 1-chloro-3,3,3-trifluoropropene (HFCO-1233zd) for the manufacture of polyurethane foams.

HFCO-1233zd is a compound that performs well as a blowing agent for polyurethane foams, due in particular to its low thermal conductivity. However, the present inventors have identified that this compound poses a problem in certain applications, and in particular in the context of the production of two-component sprayed polyurethane foam (generally referred to as “spray foam”).

Two-component sprayed polyurethane foam is produced from two precursor products, namely a composition (A) comprising an isocyanate and a composition (B) comprising a polyol formulated with a blowing agent. The two compositions are sprayed, generally by means of a gun equipped with an internal mixer, and the mixing of the two compositions is therefore carried out at the moment of spraying.

However, HFCO-1233zd has a tendency to evaporate at the most common operating temperatures. This poses specific problems during the packaging, handling and implementation of the precursor products of the foam; thus, cooling may prove necessary during packaging in order to prevent losses of HFCO-1233zd, there are risks of excess pressure appearing in the containers of precursor products during the storage or transport thereof and a large part of the blowing agent may be lost during the production of the two-component sprayed foam (that is to say during the spraying). The same problems are faced, even more acutely, for 2-chloro-3,3,3-trifluoropropene (HFCO-1233xf), the boiling point of which is even lower than that of HFCO-1233zd.

There is therefore a real need to produce a two-component sprayed polyurethane foam while avoiding the aforementioned packaging, handling and usage problems, and preferably without significantly degrading the physicochemical properties of the foam compared to a foam obtained using HFCO-1233zd or HFCO-1233xf as blowing agent.

### SUMMARY OF THE INVENTION

The invention firstly relates to the use of a composition as a blowing agent for a two-component sprayed polyurethane foam, said composition comprising 1-chloro-3,3,3-trifluoropropene and/or 2-chloro-3,3,3-trifluoropropene and at least one additional compound chosen from hydrochlorofluoroolefins, hydrofluoro-olefins, hydrochloroolefins, hydrofluorocarbons, hydrochlorofluorocarbons, hydrocarbons, substituted or unsubstituted ethers, substituted or unsubstituted alcohols, substituted or unsubstituted aldehydes, substituted or unsubstituted ketones and substituted or unsubstituted esters, and said composition having a boiling point greater than or equal to 20° C.

The boiling point may be determined as described below in example 1.

According to one embodiment of the blowing agent, the boiling point of the composition is greater than or equal to 21° C., preferably greater than or equal to 22° C., preferably greater than or equal to 23° C., preferably greater than or equal to 24° C., preferably greater than or equal to 25° C., preferably greater than or equal to 26° C., and preferably less than or equal to 30° C.

According to one embodiment, the compound used as blowing agent:
is nonflammable; and/or
has a GWP of less than or equal to 150, preferably of less than or equal to 100, preferably of less than or equal to 50, preferably of less than or equal to 25;
   and/or the two-component sprayed polyurethane foam has:
a cell size from 0.05 to 1 mm; and/or
a proportion of closed cells of greater than or equal to 90%, preferably of greater than or equal to 95%, particularly preferably of greater than or equal to 99%; and/or
a density of less than or equal to 55 kg/m³, preferably of 24 to 48 kg/m^{s}; and/or
a volume change after 48 hours at 70° C. of less than or equal to 3%, preferably of less than or equal to 1%; and/or
a volume change after 48 hours at −20° C. of less than or equal to 3%, preferably of less than or equal to 1%;
an initial thermal conductivity at 10° C. of less than or equal to 24 MW/m·K; and/or
a thermal conductivity at 10° C. after aging of less than or equal to 28 mW/m·K; and/or
a compressive strength in the direction parallel to the expansion of greater than or equal to 100 kPa, preferably of greater than or equal to 130 kPa; and/or
a compressive strength in the direction perpendicular to the expansion of greater than or equal to 90 kPa, preferably of greater than or equal to 100 kPa.

Another subject of the invention. is a process for manufacturing polyurethane foam using a blowing agent according to the invention. This process comprises:
the provision of a composition A comprising an isocyanate compound;
the provision of a composition B comprising a polyol compound and a blowing agent;
the spraying and mixing of composition A and of composition B, and the reactions of compositions A and B to provide the polyurethane foam;

wherein the blowing agent is constituted by a composition comprising 1-chloro-3,3,3-trifluoropropene and/or 2-chloro-3,3,3-trifluoropropene and at least one additional compound chosen from hydrochloro-fluoroolefins, hydrofluoroolefins, hydrochloroolefins, hydrofluorocarbons, hydrochlorofluorocarbons, hydro-carbons, substituted or unsubstituted ethers, substituted or unsubstituted alcohols, substituted or unsubstituted aldehydes, substituted or unsubstituted ketones and substituted or unsubstituted esters, said composition having a boiling point greater than or equal to 20° C.

According to one embodiment of the process according to the invention, the boiling point of the blowing agent is greater than or equal to 21 ° C., preferably greater than or equal to 22° C., preferably greater than or equal to 23° C., preferably greater than or equal to 24° C., preferably greater than or equal to 25° C., preferably greater than or equal to 26° C., and preferably less than or equal to 30° C.

According to one embodiment of the process of the invention, the blowing agent.:
is nonflammable; and/or
has a GWP of less than or equal to 50, preferably of less than or equal to 25;
   and/or the polyurethane foam has
a cell size from 0.05 to 1 mm; and/or
a proportion of closed cells of greater than or equal to 90%, preferably of greater than or equal to 95%, particularly preferably of greater than or equal to 99%; and/or
a density of less than or equal to 55 kg/m³, preferably of 24 to 48 kg/m³; and/or
a volume change after 48 hours at 70° C. of less than or equal to 3%, preferably of less than or equal to 1%; and/or
a volume change after 48 hours at −20° C. of less than or equal to 3%, preferably of less than or equal to 1%;
an initial thermal conductivity at 10° C. of less than or equal to 24 mW/m·K; and/or
a thermal conductivity at 10° C. after aging of less than or equal to 28 mW/m·K; and/or
a compressive strength in the direction parallel to the expansion of greater than or equal to 100 kPa, preferably of greater than or equal to 130 kPa; and/or
a compressive strength in the direction perpendicular to the expansion of greater than or equal to 90 kPa, preferably of greater than or equal to 100 kPa.

According to one embodiment of the blowing agent according to the invention, the additional, compound is chosen from trans-1,2dichloroethylene, ethyl tetrafluoroethyl ether, methyl acetate, methyl formate, dimethoxymethane, nonafluoroethoxybutane, 1,1,1,3,3-pentafluorobutane and mixtures thereof.

According to one embodiment of the above process, the blowing agent comprises
from 75% to 90% of 1-chloro-3,3,3-trifluoropropene and from 10% to 25% of trans-dichloroethylene; or
from 30% to 95% of 1-chloro-3,3,3-trifluoropropene and from 5% to 70% of ethyl tetrafluoroethyl ether; or
from 50% to 95% of 1-chloro-3,3,3-trifluoropropene and from 5% to 50% of nonafluoroethoxybutane; or
from 58% to 95% of 1-chloro-3,3,3-trifluoropropene and from 5% to 42% of methyl acetate; or
from 71% to 95% of 1-chloro-3,3,3-trifluoropropene and from 5% to 29% of methyl formate; or
from 81% to 86% of 1-chloro-3,3,3-trifluoropropene and from 14% to 19% of 1,1,1,3,3-penta-fluorobutane; or
from 80% to 90% of 1-chloro-3,3,3-trifluoropropene and from 10% to 20% of dimethoxymethane; or
from 60% to 85% of 2-chloro-3,3,3-trifluoropropene and from 15% to 40% of methyl acetate; or
from 70% to 80% of 2-chloro-3,3,3-trifluoropropene and from 20% to 30% of trans-dichloroethylene.

Another subject of the invention is a particular composition for the implementation of the above process, comprising 1-chloro-3,3,3-trifluoropropene and at least one additional compound chosen from nonafluoroethoxybutane and ethyl tetrafluoroethyl ether.

According to one embodiment, this composition comprises:
1-chloro-3,3,3-trifluoropropene and nonafluoro-ethoxybutane in a weight ratio from 50:50 to 95:5; or
1-chloro-3,3,3-trifluoropropene and ethyl tetrafluoroethyl ether in a weight ratio from 30:70 to 95:5.

Another subject of the invention is another particular composition for the implementation of the above process, comprising 2-chloro-3,3,3-trifluoropropene and at least one additional compound chosen from methyl acetate, methyl formate, dimethoxymethane, trans-dichloroethylene, ethyl tetrafluoroethyl ether and nonafluoroethoxybutane.

According to one embodiment, this composition comprises:
2-chloro-3,3,3-trifluoropropene and methyl acetate in a weight ratio from 60:40 to 85:15; or
2-chloro-3,3,3-trifluoropropene and trans-dichloroethylene in a weight ratio from 70:30 to 80:20.

According to one embodiment, one of the above compositions additionally comprises a polyol compound, preferably in a weight content from 60% to 90%,

The present invention makes it possible to overcome the drawbacks of the prior art. It provides, more particularly, a blowing agent for the production of two-component sprayed polyurethane foam, said blowing agent making it possible to avoid the packaging, handling and usage problems encountered with HFCO-1233zd or HFCO-1233xf.

This is accomplished by adding at least one co-blowing agent in combination with the HFCO-1233zd or the HFCO-1233xf, the mixture thus obtained having a boiling point above that of the HFCO-1233zd alone (around 18° C.) or of the HFCO-1233xf alone (around 13° C.), and more particularly a boiling point above ambient temperature in most situations.

According to certain particular embodiments, the invention also has one or preferably several advantageous features listed below.
The blowing agent according to the invention has acceptable properties with respect to environmental constraints (especially low GWP), toxicity and safety (non-flammability). It is soluble in polyols.
The polyurethane foam obtained owing to the invention has acceptable properties for thermal conductivity, density, dimensional stability, cell structure and compressive strength; preferably, these properties are as satisfactory or practically as satisfactory as the properties of a two-component sprayed polyurethane foam obtained with HFCO-1233zd alone (respectively with HFCO-1233xf alone) as blowing agent.
The mixing of the blowing agent with the polyol compound may be carried out at ambient temperature without risking excessive loss of blowing agent, which is more economical and facilitates the use of the blowing agent.
The vapor pressure of the polyol formulated with the blowing agent is lower, which limits the risk of achieving pressures above the operating pressure of the containers (drums) used.
The losses of blowing agent are limited during the production of the foam, in the event of relatively high temperature.

### DESCRIPTION OF EMBODIMENTS OF THE INVENTION

The invention is now described in greater detail and nonlimitingly in the description which follows.

All the percentages indicated refer to values by weight unless otherwise mentioned.

### Blowing Agent

The invention is based on the use of compositions based on 1-chloro-3,3,3-trifluoropropene (HFCO-1233zd) or on 2-chloro-3,3,3-trifluoropropene (HFCO-1233xf) and on at least one co-blowing agent (additional compound) as a blowing agent within the context of the production of two-component sprayed polyurethane foam. The invention also provides certain compositions as such, suitable for the above use.

Generally, the additional compound is chosen so that its boiling point is greater than that of HFCO-1233zd, in order that the boiling point of the composition comprising HFCO-1233zd and the additional compound or compounds is greater than or equal to 20° C. or 21° C. or 22° C. or 23° C. or 24° C. or 25° C. or 26° C., and preferably less than or equal to 30° C.

The blowing agent may especially be a binary composition consisting essentially of HFCO-1233zd and a single additional compound, or a binary composition consisting essentially of HFCO-1233xf and a single additional compound, or a ternary composition consisting essentially of HFCO-1233zd and two additional compounds, or a ternary composition consisting essentially of HFCO-1233xf and two additional compounds, or a ternary composition consisting essentially of HFCO-1233zd, HFCO-1233xf and a single additional compound.

The expression “consisting essentially of” means that the composition may optionally comprise, besides the aforementioned compounds, a proportion of impurities or other additives of less than or equal to 1%, preferably of less than or equal to 0.5%, or even of less than or equal to 0.1%.

The HFCO-1233zd is preferably in its trans form, which has the advantage of a lower toxicity compared to the cis form. The trans form advantageously represents at least 80% by weight of the HFCO-1233zd, preferably at least 90% by weight, more particularly preferably at least 95% by weight, for example at least 98% by weight. Ideally, essentially all of the HFCO-1233zd is in trans form.

The additional compounds are generally chosen from hydrochlorofluoroolefins (alkenes having chlorine and fluorine substituents), hydrofluoroolefins (alkenes having fluorine substituents), hydrochloroolefins (alkenes having chlorine substituents), saturated or unsaturated hydrocarbons (in particular alkanes or alkenes), hydrofluorocarbons (hydrocarbons having fluorine substituents), hydrochlorofluorocarbons (hydrocarbons having fluorine and chlorine substituents) substituted or unsubstituted ethers (especially halogenated ethers, comprising chlorine and/or fluorine substituents), substituted or unsubstituted alcohols (especially halogenated alcohols, comprising chlorine and/or fluorine substituents), substituted or unsubstituted aldehydes (especially halogenated aldehydes, comprising chlorine and/or fluorine substituents), substituted or unsubstituted ketones (especially halogenated ketones, comprising chlorine and/or fluorine substituents) and substituted or unsubstituted esters (especially halogenated esters, comprising chlorine and/or fluorine substituents), and mixtures thereof.

The preferred additional compounds are trans-1,2-dichloroethylene (or TDCE), ethyl tetrafluoroethyl ether (or ETFEE), methyl acetate, methyl formate, dimethoxymethane, nonafluoroethoxybutane (or HFE-7200), 1,1,1,3,3-pentafluorobutane (or HFC-365mfc) and mixtures thereof.

The nature and the amount of additional compound(s) are chosen so that preferably the composition nonflammable (in view of the risks linked to the emissions of vapor during spraying) and so that preferably the GWP of the composition is as low as possible (preferably less than or equal to 150 or 100 or 50 or 25).

The flammability or the nonflammability of the composition are determined in the liquid phase of the composition, in accordance with the standard ASTM D3828.

According to the present application, the global warming potential (GWP) is defined relative to carbon dioxide and relative to a duration of 100 years, according to the method indicated in “The scientific assessment of ozone depletion, 2002, a report of the World Meteorological Association's Global Ozone Research and Monitoring Project”.

The nature and the amount of the additional compound(s) are chosen so that preferably the polyurethane foam obtained by reaction of an isocyanate compound and of a polyol compound. in the presence of the blowing agent of the invention has the following properties:
a cell size from 0.05 to 1 mm determined by scanning electron microscopy;
a proportion of closed cells of greater than or equal to 90%, preferably greater than or equal to 95%, particularly preferably greater than or equal to 99%, determined according to the standard ASTM D2856-87 using a gas pycnometer;
a density of less than or equal to 55 kg/m³, preferably of 24 to 48 kg/m³ (standard ISO 845:2006);
a volume chancre after 48 hours at 70° C. of less than or equal to 3% (preferably of less than or equal to 1%) and a volume change after 48 hours at −20° C. of less than or equal to 3% (preferably of less than or equal to 1%)
an initial thermal conductivity at 10° C. of less than or equal to 24 mW/m·K (standard ISO 8301);
a thermal conductivity at 10° C. after aging of less than or equal to 28 mW/m·K (standard ISO 8301);
a compressive strength measured according to the standard ASTM D1621-00 in the direction parallel to the expansion of greater than or equal to 100 kPa, preferably of greater than or equal to 130 kPa;
a compressive strength measured according to the standard ASTM D1621-00 in the direction perpendicular to the expansion of greater than or equal to 90 kPa, preferably of greater than or equal to 100 kPa.

HFCO-1233zd or HFCO-1233xf in general impart excellent properties to the polyurethane foam (in terms of thermal conductivity, density, dimensional stability, cell structure and compressive strength). It is therefore desired that the blowing agent used according to the invention imparts to the polyurethane foam properties as close as possible to those obtained with HFCO-1233zd (respectively with HFCO-1233xf), in particular as regards the thermal conductivity, density, dimensional stability, cell structure and the compressive strength.

For this purpose, it is preferable for the proportion of HFCO-1233zd and/or of HFCO-1233xf in the blowing agent composition to be greater than or equal to 50%, and preferably greater than or equal to 55% or 60% or 65% or 70% or 75% or 80%.

Preferred compositions are the following:
mixture consisting or essentially consisting of HFCO-1233zd and TDCE: from. 75% to 90% of HFCO-1233zd and from 10% to 25% of TDCE;
mixture consisting or essentially consisting of HFCO-1233zd and ETFEE: from 30% to 95% of HFCO-1233zd and from 5% to 70% of ETFEE;
mixture consisting or essentially consisting of HFCO-1233zd and HFE-7200: from 50% to 95% of HFCO-1233zd and from 5% to 50% of HFE-7200;
mixture consisting or essentially consisting of HFCO-1233zd and methyl acetate: from 58% to 95% of HFCO-1233zd and from 5% to 42% of methyl acetate;
mixture consisting or essentially consisting of HFCO-1233zd and methyl formate: from 71% to 95% of HFCO-1233zd and from 5% to 29% of methyl formate;
mixture consisting or essentially consisting of HFCO-1233zd and HFC-365mfc: from 81% to 86% of HFCO-1233zd and from 14% to 19% of HFC-365mfc;
mixture consisting or essentially consisting of HFCO-1233zd and dimethoxymethane: from 80% to 90% of HFCO-1233zd and from 10% to 20% of dimethoxy-methane;
mixture consisting or essentially consisting of HFCO-1233xf and methyl acetate: from 60% to 85% of HFCO-1233xf and from 15% to 40% of methyl acetate;
mixture consisting or essentially consisting of HFCO-1233xf and TDCE: from 70% to 80% of HFCO-1233xf and from 20% to 30% of TDCE.

The upper limits of the contents of HFCO-1233zd in the above preferred compositions are mainly dictated by the criterion of the boiling point, which is desired to be greater than or equal to around 20° C.

If a binary HFCO-1233zd/TDCE mixture contains less than 75% of HFCO-1233zd, a loss of dimensional stability of the polyurethane foam is witnessed.

If a binary HFCO-1233zd/ETFFE mixture contains less than 30% of HFCO-1233zd, the mixture is flammable,

If a binary HFCO-1233zd/methyl acetate mixture contains less than 58% of HFCO-1233zd, the mixture is flammable.

If a binary HFCO-1233zd/methyl formate mixture contains less than 71% of HFCO-1233zd, the mixture is flammable.

If a binary HFCO-1233zd/HFC-365mfc mixture contains less than 81% of HFCO-1233zd, the mixture has a GWP of greater than 150.

### Production of Polyurethane Foam

According to the invention, the two-component sprayed polyurethane foam is manufactured from a composition A comprising an isocyanate compound and a composition B comprising a polyol compound and the above blowing agent. The two compositions are sprayed and mixed at the moment of spraying (generally by means of a gun provided with an internal mixer). The reaction between the polyol compound and the isocyanate compound in order to form the polyurethane takes place in situ, that is to say at the location where the foam is applied.

The “two-component sprayed polyurethane foam” may also be referred to as spray foam. It differs from one-component polyurethane foam (or OCF) which is manufactured using an aerosol in which both the formulated polyol and the isocyanate are mixed, the blowing agent then acting as propellant (in one-component foams, it is desirable to have a blowing agent of low boiling point, such as trans-HFO-1234ze which has a boiling point of −19° C.).

The composition B preferably comprises from 50% to 90% of polyol compound and from 5% to 30% of blowing agent,

The expression “polyl compound” is understood to mean. a polyol or a mixture of polyols. Examples of suitable polyols are glycerol, ethylene glycol, trimethylol-propane, pentaerythritol, polyether polyols, for example those obtained by condensation of an alkylene oxide or of a mixture of alkylene oxides with glycerol, ethylene glycol, trimethylolpropane or pentaerythritol, polyester polyols, for example those obtained from polycarboxylic acids, in particular oxalic acid, malonic acid, succinic acid, adipic acid, maleic acid, fumaric acid, isophthalic acid or terephthalic acid, with glycerol, ethylene glycol, trimethylolpropane or pentaerythritol.

The polyether polyols obtained by addition of alkylene oxides, in particular ethylene oxide and/or propylene oxide, to aromatic amines, in particular the mixture of 2,4-toluenediamine and 2,6-toluenediamine, are also suitable. Polyether polyols are particularly preferred.

As other types of polyols, mention may especially be made of hydroxyl-terminated polythioethers, polyamides, polyesteramides, polycarbonates, polyacetals, polyolefins and polysiloxanes.

The composition B may also comprise one or more surfactants and one or more catalysts as is known in the field, preferably in a total amount of between 5% and 20%.

The composition A comprises an isocyanate compound which is preferably an organic polyisocyanate.

As the organic polyisocyanate, mention may be made of aliphatic polyisocyanates having a hydrocarbon-based group comprising up to 18 carbon atoms, cycloaliphatic polyisocyanates having a hydrocarbon-based group comprising no to 15 carbon atoms, aromatic polyisocyanates having a hydrocarbon-based group comprising from 6 to 15 carbon atoms and aryialiphatic polyisocyanates having a hydrocarbon-based group comprising from 8 to 15 carbon atoms.

The preferred polyisocyanates are 2,4-toluene diisocyanate and 2,6-toluene diisocyanate, diphenyl methane diisocyanate polymethylene polyphenyl isocyanate and mixtures thereof. Modified polyiso-cyanates, such as those comprising carbodiimide groups, urethane groups, isocyanurate groups, urea groups or biurea groups may also be suitable.

### EXAMPLES

The following example illustrates the invention without limiting it.

### Example 1

### Boiling Points of Blowing Agents

The technique used for measuring the temperature or the compositions is the ebulliometry method.

An ebulliometer consisting of a round-bottom flask maintained at ambient pressure (1.013 bar) and surmounted by a condenser is charged with at least 50% of its volume of HECO-1233zd (or of HFCO-1233xf). The HFCO-1233zd is heated to boiling and the temperature is measured. The round-bottom flask is cooled and another component is added to the round-bottom flask in small predetermined amounts. After each addition, the mixture is brought to boiling and the temperature of the medium is measured.

The measured temperature of the composition is corrected as a function of the measured temperature of HFCO-1233zd.

The results are summarized in table 1 below. The uncertainty is ±1% on the composition and ±0.5° C. on the temperature.

TABLE 1
Boiling point of blowing agents

| | Corrected |
|---|---|
| | boiling |
| Blowing agent | point |
| 90% of HFCO-1233zd + 10% of ETFEE | 20.8° C. |
| 77% of HFCO-1233zd + 23% of ETFEE | 23.9° C. |
| 69% of HFCO-1233zd + 31% of ETFEE | 26.0° C. |
| 60% of HFCO-1233Zd + 40% of ETFEE | 28.9° C. |
| 90% of HFCO-1233zd + 10% of HFE-7200 | 20.9° C. |
| 80% of HFCO-1233zd + 20% OF HFE-7200 | 22.3° C. |
| 70% of HFCO-1233zd + 30% of HFE-7200 | 23.8° C. |
| 60% of HFCO-1233zd + 40% of HFE-7200 | 25.4° C. |
| 98% of HECO-1233zd + 2% of methyl acetate | 19.8° C. |
| 95% of HFCO-1233zd + 5% of methyl acetate | 21.0° C. |
| 90% of HFCO-1233zd + 10% of methyl acetate | 23.6° C. |
| 80% of HFCO-1233zd + 20% of methyl acetate | 29.2° C. |
| 65% of HFCO-1233zd + 35% of methyl acetate | 35.7° C. |
| 96% of HFCO-1233zd + 4% of methyl formate | 19.5° C. |
| 91% of HFCO-1233zd + 9% of methyl formate | 21.2° C. |
| 80% of HFCO-1233zd + 20% of methyl formate | 22.3° C. |
| 90% of HFCO-1233zd + 10% of TDCE | 20.0° C. |
| 80% of HFCO-1233zd + 20% of TDCE | 22.6° C. |
| 60% of HFCO-1233zd + 40% of TDCE | 26.8° C. |
| 93% of HFCO-1233zd + 7% of HFC-365mfc | 19.3° C. |
| 86% of HFCO-1233zd + 14% of HFC-365mfc | 20.0° C. |
| 72% of HFCO-1233zd + 28% of HFC-365mfc | 21.7° C. |
| 59% of HFCO-1233zd + 41% of HFC-365mfc | 23.0° C. |
| 85% of HFCO-1233xf + 15% of methyl acetate | 20.7° C. |
| 64% of HFCO-1233xf + 36% of methyl acetate | 29.1° C. |
| 79% of HFCO-1233xf + 21% of TDCE | 18.3° C. |
| 69% of HFCO-1233xf + 31% of TDCE | 20.4° C. |

1. A blowing agent-composition for a two-component sprayed polyurethane foam, comprising 1-chloro-3,3,3-trifluoropropene and/or 2-chloro-3,3,3-trifluoropropene and at least one additional compound selected from the group consisting of hydrochloro-fluoroolefins, hydrofluoroolefins, hydrochloroolefins, hydrofluorocarbons, hydro-chlorofluorocarbons, hydrocarbons, substituted or unsubstituted ethers, substituted or unsubstituted alcohols, substituted or unsubstituted aldehydes, substituted or unsubstituted ketones and substituted or unsubstituted esters, said blowing agent composition having a boiling point greater than or equal to 20° C.

2. The blowing agent composition claimed in claim 1, wherein the boiling point of the composition is greater than or equal to 21° C.

3. The blowing agent composition claimed in claim 1, wherein the composition:
is nonflammable; and/or
has a GWP of less than or equal to 150;
and/or wherein the two-component sprayed polyurethane foam has:
a cell size from 0.05 to 1 mm; and/or
a proportion of closed cells of greater than or equal to 90; and/or
a density of less than or equal to 55 kg/m³, and/or
a volume change after 48 hours at 70° C. of less than or equal to 3%; and/or
a volume change after 48 hours at −20° C. of less than or equal to 3%,;
an initial thermal conductivity at 10° C. of less than or equal to 24 mW/m·K; and/or
a thermal conductivity at 10° C. after aging of less than or equal to 28 mW/m·K; and/or
a compressive strength in the direction parallel to the expansion of greater than or equal to 100 kPa; and/or
a compressive strength in the direction perpendicular to the expansion of greater than or equal to 90 kPa.

4. The blowing agent composition claimed in claim 1, wherein the additional compound is selected from the group consisting of trans-1,2-dichloroethylene, ethyl tetrafluoroethyl ether, methyl acetate, methyl foliage, dimethoxymethane, nonafluoroethoxybutane, 1,1,1,3,3-pentafluorobutane and mixtures thereof.

5. The blowing agent composition claimed in claim 4, wherein the composition comprises:
from 30% to 90% of 1-chloro-3,3,3-trifluoropropene and from 10% to 70% of trans-dichloroethylene.

6. A process for manufacturing polyurethane foam, comprising:
spraying and mixing of an isocyanate compound composition A and a polyol compound and a blowing agent composition B, and reacting compositions A and B to provide the polyurethane foam;
wherein the blowing agent comprises a composition comprising 1-chloro-3,3,3-trifluoropropene and/or 2-chloro-3,3,3-trifluoropropene and at least one additional compound selected from the group consisting of hydrochloro-fluoroolefins, hydrofluoroolefins, hydrochloroolefins, hydrofluorocarbons, hydrochlorofluorocarbons, hydrocarbons, substituted or unsubstituted ethers, substituted or unsubstituted alcohols, substituted or unsubstituted aldehydes, substituted or unsubstituted ketones and substituted or unsubstituted esters, said composition having a boiling point greater than or equal to 20° C.

7. The process as claimed in claim 6, wherein the boiling point of the blowing agent is greater than or equal to 21° C.

8. The process as claimed in claim 6, wherein the blowing agent:
is nonflammable; and/or
has a GWP of less than or equal to 50; and/or wherein the polyurethane foam has:
a cell size from 0.05 to 1 mm; and/or
a proportion of closed cells of greater than or equal to 90; and/or
a density of less than or equal to 55 kg/m³, preferably of 24 to 48 kg/m³; and/or
a volume change after 48 hours at 70° C. of less than or equal to 3%; and/or
a volume change after 48 hours at −20° C. of less than or equal to 3%
an initial thermal conductivity at 10° C. of less than or equal to 24 mW/m·K; and/or
a thermal conductivity at 10° C. after aging of less than or equal to 28 mW/m·K; and/or
a compressive strength in the direction parallel to the expansion of greater than or equal to 100 kPa; and/or
a compressive strength in the direction perpendicular to the expansion of greater than or equal to 90 kPa.

9. The process as claimed in claim 6, wherein the additional compound is selected from the group consisting of trans-1,2-dichloroethylene, ethyl tetrafluoroethyl ether, methyl acetate, methyl formate, dimethoxymethane, nonafluoroethoxybutane, 1,1,1,3,3-pentafluorobutane and mixtures thereof.

10. The process as claimed in claim 9, wherein the blowing agent comprises:
from 30% to 90% of 1-chloro-3,3,3-trifluoropropene and from 10% to 70% of trans-dichloroethylene.

11. A composition comprising 1-chloro-3,3,3-trifluoropropene and at least one additional compound selected from the group consisting of nonafluoroethoxybutane and ethyl tetrafluoroethyl ether.

12. The composition as claimed in claim 11, comprising:
1-chloro-3,3,3-trifluoropropene and nonafluoroethoxybutane in a weight ratio from 50:50 to 95:5.

13. A composition comprising 2-chloro-3,3,3-trifluoropropene and at least one additional compound selected from the group consisting of methyl acetate, methyl formate, dimethoxymethane, trans-dichloroethylene, ethyl tetrafluoroethyl ether and nonafluoroethoxybutane.

14. The composition as claimed in claim 13, comprising:
2-chloro-3,3,3-trifluoropropene and methyl acetate in a weight ratio from 60:40 to 85:15.

15. The composition as claimed in claim 11 further comprising a polyol compound.

16. The blowing agent composition claimed in claim 2, wherein the boiling point of the composition less than or equal to 30° C.

17. The blowing agent composition claimed in claim 4, wherein the composition comprises from 60% to 85% of 2-chloro-3,3,3-trifluoropropene and from 15% to 40% of methyl acetate.

18. The process as claimed in claim 7, wherein the boiling point of the blowing agent is less than or equal to 30° C.

19. The process as claimed in claim 9, wherein the blowing agent comprises: from 60% to 85% of 2-chloro-3,3,3-trifluoropropene and from 15% to 40% of methyl acetate.

20. The composition as claimed in claim 11, comprising 1-chloro-3,3,3-trifluoropropene and ethyl tetrafluoroethyl ether in a weight ratio from 30:70 to 95:5.

21. The composition as claimed in claim 13, comprising: 2-chloro-3,3,3-trifluoropropene and trans-dichloroethylene in a weight ratio from 70:30 to 80:20.

22. The composition as claimed in claim 15 wherein said polyol compound is present in a weight content from 60% to 90%.
